(19) United States
(12) Patent Application Publication
(10) Pub. No.: US 2026/0060306 A1
(43) Pub. Date: Mar. 5, 2026

(54) AEROSOL-GENERATING DEVICE AND HEATING STRUCTURE

(71) Applicant: SMOORE INTERNATIONAL HOLDINGS LIMITED, George Town (KY)

(72) Inventors: Lei MA, Shenzhen (CN); Xingfu ZHANG, Shenzhen (CN); Hongming ZHOU, Shenzhen (CN); Rihong LI, Shenzhen (CN); Xianwu DU, Shenzhen (CN); Guo ZHANG, Shenzhen (CN)

(21) Appl. No.: 19/383,610

(22) Filed: Nov. 8, 2025

Related U.S. Application Data
(63) Continuation of application No. PCT/CN2024/091483, filed on May 7, 2024.

(30) Foreign Application Priority Data
May 9, 2023 (CN) 202310520692.1

(51) Int. Cl. A24F 40/46; A24F 40/20

(52) U.S. Cl. CPC A24F 40/46; A24F 40/20

(57) ABSTRACT

A heating structure includes: a tube body having a cavity and a pipe wall transparent to infrared light; and a heating element at least partially arranged in the cavity, at least partially spaced apart from the pipe wall, and that radiates infrared light to pass through the tube body so as to heat an aerosol-generating substrate. The heating element has a first dimension in a transverse direction. The cavity has a second dimension in the transverse direction. A ratio of the first dimension to the second dimension is greater than or equal to 0.65 and less than 1.

### CROSS-REFERENCE TO PRIOR APPLICATION

This application is a continuation of International Patent Application No. PCT/CN2024/091483, filed on May 7, 2024, which claims priority to Chinese Patent Application No. 202310520692.1, filed on May 9, 2023. The entire disclosure of both applications is hereby incorporated by reference herein.

### FIELD

The present disclosure relates to the field of heat-not-burn atomization and particularly, to an aerosol-generating device and a heating structure.

### BACKGROUND

In the field of heat-not-burn (HNB) atomization, generally, heating methods such as central heating element heating or peripheral heating element heating are adopted. Typically, a heating element generates heat, and then the heat is directly transferred to an aerosol-forming substrate through heat conduction. The substrate is generally atomized at the temperature of about 350° C. However, the drawback of this heating method is that: the heating element transfers the heat directly to the aerosol-forming substrate, requiring the heating element to operate within 400° C. If the temperature is too high, the aerosol-forming substrate generates a peculiar smell to affect the vaping experience. However, a not high temperature directly causes low heating efficiency.

### SUMMARY

In an embodiment, the present invention provides a heating structure, comprising: a tube body having a cavity and a pipe wall transparent to infrared light; and a heating element at least partially arranged in the cavity, at least partially spaced apart from the pipe wall, and configured to radiate infrared light to pass through the tube body so as to heat an aerosol-generating substrate, wherein the heating element has a first dimension in a transverse direction, wherein the cavity has a second dimension in the transverse direction, and wherein a ratio of the first dimension to the second dimension is greater than or equal to 0.65 and less than 1.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of the assembly of an aerosol-generating device and an aerosol-generating substrate in a first embodiment of the present disclosure;

FIG. 2 is a sectional view of the aerosol-generating device shown in FIG. 1;

FIG. 3 is a schematic structural diagram of a heating component 10 in the aerosol-generating device shown in FIG. 2;

FIG. 4 is a sectional view of the heating component 10 shown in FIG. 3;

FIG. 5 is an exploded view of the heating component 10 shown in FIG. 4;

FIG. 6 is a schematic structural diagram of a heating structure in the heating component 10 shown in FIG. 5;

FIG. 7 is a sectional view of a heating structure shown in FIG. 6;

FIG. 8 is an exploded view of the heating structure shown in FIG. 7;

FIG. 9 is a sectional view of the heating structure shown in FIG. 7;

FIG. 10 is a schematic structural diagram of a heating structure in an aerosol-generating device according to a second embodiment of the present disclosure;

FIG. 11 is a schematic structural diagram of a heating element of a heating structure in an aerosol-generating device according to a third embodiment of the present disclosure;

FIG. 12 is a schematic structural diagram of a heating element of a heating structure in an aerosol-generating device according to a fourth embodiment of the present disclosure;

FIG. 13 is a schematic structural diagram of a heating element of a heating structure in an aerosol-generating device according to a fifth embodiment of the present disclosure; and

FIG. 14 is a schematic structural diagram of a heating element of a heating structure in an aerosol-generating device according to a sixth embodiment of the present disclosure.

### DETAILED DESCRIPTION

In an embodiment, the present invention provides an improved aerosol-generating device and a heating structure.

In an embodiment, the present invention provides a heating structure,
including:
a tube body, having a cavity and a pipe wall transparent to infrared light; and
a heating element, at least partially arranged in the cavity, at least partially spaced apart from the pipe wall, and configured to radiate infrared light which penetrates through the tube body to heat an aerosol-generating substrate.

The heating element has a first dimension in the transverse direction, the cavity has a second dimension in the transverse direction, and a ratio of the first dimension to the second dimension is more than or equal to 0.65 and less than 1.

In some embodiments, the tube body includes a main body portion and a pointed top portion arranged at one end of the main body portion, and the interior of the main body portion is hollow and forms at least part of the cavity.

In some embodiments, a heating portion has a spiral column shape, and the first dimension is the radial dimension of the heating portion, and is 0.6 mm to 2.5 mm.

In some embodiments, the cross section of the cavity has a circular shape, and the second dimension is the radial dimension of the cavity, and is 0.7 mm to 3 mm.

In some embodiments, the heating portion is arranged longitudinally, and has the length of 5 mm to 12 mm.

In some embodiments, a first high-temperature area is formed on the heating element, and the length of the first high-temperature area is more than or equal to one third of the length of the aerosol-generating substrate and less than or equal to three quarters of the length of the aerosol-generating substrate.

In some embodiments, the length of the first high-temperature area is 5 mm to 11 mm.

In some embodiments, a second high-temperature area is formed on some segments on the outer side of the pipe wall of the tube body, is located on the periphery of the first high-temperature area, and has the length of 7 mm to 12 mm.

In some embodiments, the thickness of the pipe wall of the tube body is 0.2 mm to 0.5 mm.

In some embodiments, the length of the tube body is 13 mm to 29 mm.

In some embodiments, a gap between the inner wall of the main body portion and the heating portion is 0.05 mm to 0.5 mm.

In some embodiments, the heating portion is completely not in contact with the inner wall of the main body portion.

In some embodiments, the heating structure further includes a conductive portion; the heating portion has a first end portion and a second end portion in the axial direction of the heating portion; the conductive portion is arranged at the second end portion; and the conductive portion is led out from the tube body.

In some embodiments, the outer side wall of the tube body is provided with a positioning portion for installation and positioning;
the tube body includes a pipe opening for leading out the conductive portion;
the positioning portion is arranged close to the pipe opening; and
the distance between the second end portion and the positioning portion is more than or equal to one tenth of the length of the tube body and less than or equal to three quarters of the length of the tube body.

In some embodiments, the distance between the second end portion and the positioning portion is 2 mm to 12 mm.

The present disclosure further discloses an aerosol-generating device, including the heating structure according to the present disclosure and a power supply component connected to the heating structure.

The following beneficial effects are obtained when the aerosol-generating device and the heating structure of the present disclosure are implemented. According to the heating structure, the ratio of the first dimension of the heating element in the transverse direction to the second dimension of the cavity in the transverse direction is more than or equal to 0.65 and less than 1, and the maximum operating temperature of the heating element can reach more than 500° C. Therefore, the limitation to the dimensional structure can not only avoid a fact that the heating element is excessively thin to cause excessive resistance, but also ensure that the aerosol-generating substrate is rapidly heated to quickly generate smoke without power increase or addition of a boost module, manufacturing costs of the heating structure are reduced, and the degree of high-temperature deformation of the heating element is reduced to maintain a set spacing between the heating element and the pipe wall of the tube body. The dimension of the tube body is controlled not to be excessively large while ensuring that the heating element does not adhere to the wall of the tube body, to avoid causing excessive vaping resistance during vaping or difficult assembly of the tube body with the aerosol-generating substrate, thereby improving the working stability of the heating structure and further improving consumer experience. In addition, the dimensional ratio of the heating element to the cavity in the tube body can ensure that the aerosol-generating substrate cannot be burned when a heating body is at a high temperature above 500° C., and can achieve rapid temperature rise and improve heating efficiency.

In the figures, 100: aerosol-generating device; 200: aerosol-generating substrate; 10: heating component; 20: power supply component; 30: housing; 40: extractor; 11: heating structure; 111: tube body; 111a: main body portion; 111b: pointed top portion; 1110: cavity; 1111: pipe opening; 112: heating element; 1120: heating body; 112a: heating substrate; 112b: heat radiating layer; 112c: anti-oxidation layer; 1121: heating portion; 112M: first end portion; 112N: second end portion; 1122: conductive portion; 1123: connection portion; 113: insulating part; 113a: first end; 113b: second end; 1131: channel; 114: positioning portion; 12: holder; 121: holder body; 1210: accommodating cavity; 122: supporting wall; 123: mounting hole; 13: base; 131: bottom wall; 132: limiting structure; 1321: limiting protruding stage; 14: sealing structure; 1124: spiral segment; 1125: annular portion; and 1126: bending portion.

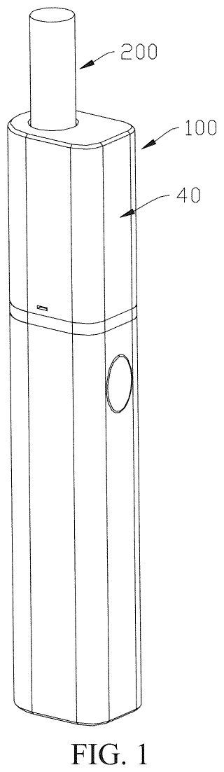

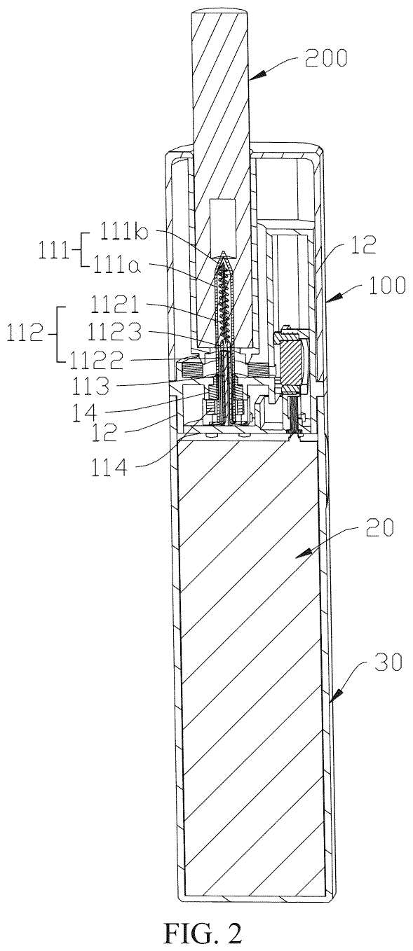

FIG. 1 and FIG. 2 show some preferred embodiments of an aerosol-generating device according to the present disclosure. The aerosol-generating device 100 may heat an aerosol-generating substrate 200 in a low-temperature heat-not-burn manner, and has good atomization stability and good atomization experience. In some embodiments, the aerosol-generating substrate 200 may be arranged in a pluggable manner on the aerosol-generating device 100. The aerosol-generating substrate 200 may be cylindrical. Specifically, the aerosol-generating substrate 200 may be a solid material that is in a string shape, a sheet shape, or integrated and that is made of leaves and/or stalks of a plant (such as tobacco), and an aroma component may be further added to the solid material. The aerosol-generating device 100 has the advantages of simple assembly, good assembly stability, and long service life.

As shown in FIG. 1 and FIG. 2, in this embodiment, the aerosol-generating device 100 includes a heating component 10, a power supply component 20, and a housing 30. The heating component 10 may be partially inserted into the aerosol-generating substrate 200. Specifically, the heating component 10 may be at least partially inserted into a substrate segment of the aerosol-generating substrate 200, and, in a powered-on state, radiates infrared light to heat the substrate segment of the aerosol-generating substrate 200, to atomize the substrate segment and generate aerosol. The heating component 10 has the advantages of simple assembly, a simple structure, high atomization efficiency, strong stability, and long service life. The power supply component 20 is configured to supply power to the heating component 10. The housing 30 may accommodate the power supply component 20 and may be assembled with the heating component 10. In some embodiments, the aerosol-generating device 100 includes an extractor 40, and the extractor 40 may be assembled with the heating component 10 and is configured to accommodate the aerosol-generating substrate 200.

According to the heating component of the present disclosure, the maximum operating temperature of a heating element of the heating component may reach more than 500° C., or even about 1000° C., the heating element can further radiate infrared light, especially infrared light at wavelengths of 2-4.75 μm and 8-11 μm, and when the aerosol-generating substrate is heated, not only smoke can be generated rapidly, but also a burning smell cannot be generated to ensure a good vaping experience. Therefore, the dimensional requirement for the heating element, the dimensional requirement for the tube body, and the matching dimensional relationship between the heating element and the tube body need to be innovatively configured.

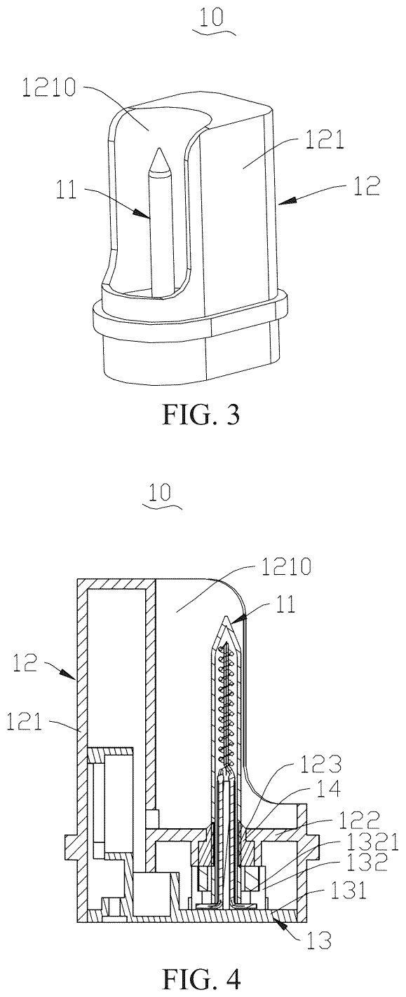

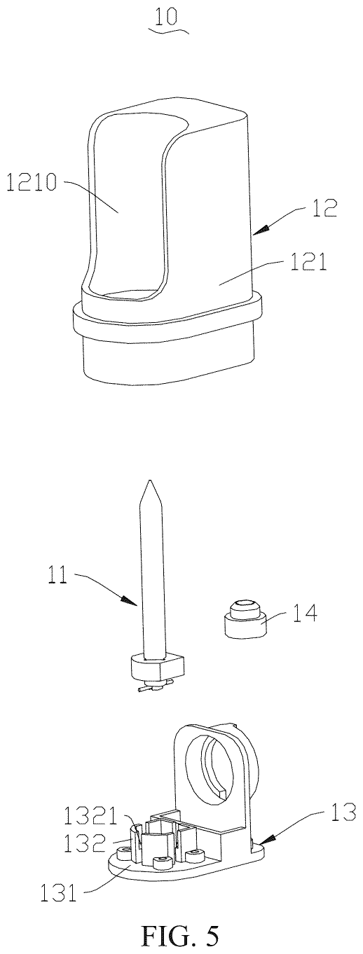

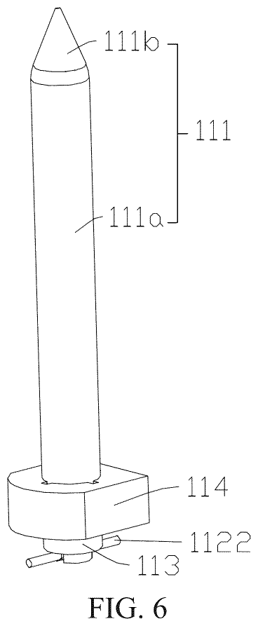

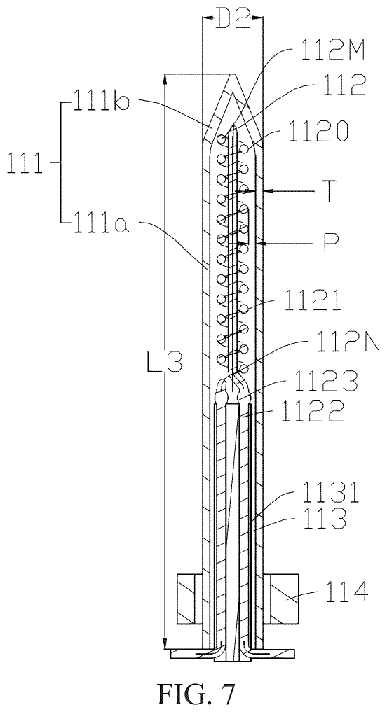

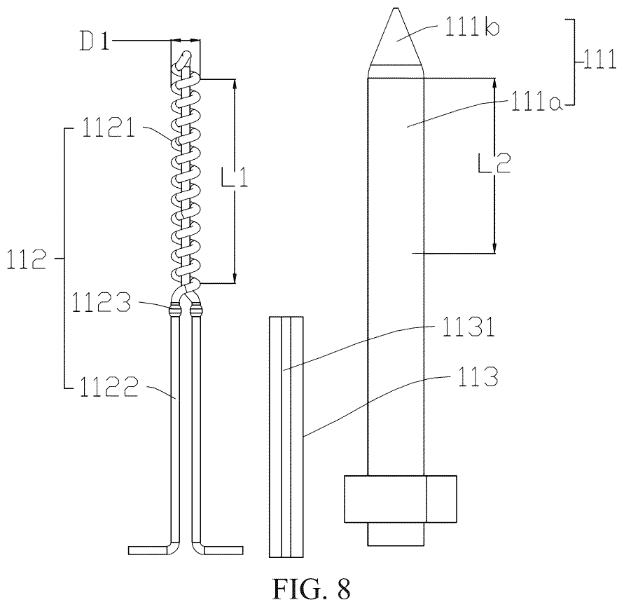

As shown in FIG. 3 to FIG. 8, further, in this embodiment, the heating component 10 includes a heating structure 11 and a holder 12. The heating structure 11 is arranged on the holder 12, and at least partially inserted into the aerosol-generating substrate 200, to heat the aerosol-generating substrate 200 by radiating infrared light. The heating structure 11 may be inserted in the axial direction of the aerosol-generating substrate 200, and may be located at the central axis of the aerosol-generating substrate 200. It may be understood that, in some other embodiments, the heating structure 11 may alternatively be sleeved on the periphery of the aerosol-generating substrate 200, and radiates infrared light toward the aerosol-generating substrate 200. The holder 12 is configured to mount and fix the whole heating structure 11, to achieve a function of supporting the heating structure 11. In some embodiments, the holder 12 may be omitted.

In this embodiment, the heating structure 11 includes a tube body 111 and a heating element 112. In some embodiments, the tube body 111 covers at least part of the heating element 112, and may allow light waves to pass through to the aerosol-generating substrate 200. Specifically, in this embodiment, the tube body 111 has a pipe wall that allows infrared light to pass through, to further facilitate radiation of the infrared light from the heating element 112 to heat the aerosol-generating substrate 200. In some embodiments, the heating element 112 is at least partially arranged in the tube body 111, and is configured to radiate infrared light, and the infrared light may pass through the tube body 111 and enter the aerosol-generating substrate 200. In a powered-on state, the heating element 112 rapidly heats up to about 1000° C. within 1-3 s, while the surface temperature of the tube body 111 may be controlled below 350° C., and the atomization temperature of the aerosol-generating substrate 200 as a whole is controlled at 300-350° C., whereby the aerosol-generating substrate 200 is accurately atomized in a waveband of 2-4.75 μm. The maximum operating temperature of the heating element 112 of the present disclosure is 500° C. to 1300° C., which is far higher than the maximum operating temperature of a heating element in the prior art, and the transient local temperature of the tube body 111 may also reach up to 550° C. In some other embodiments, the heating element 112 may alternatively be arranged as a whole in the tube body 111.

In this embodiment, the tube body 111 may be a quartz glass pipe. Of course, it may be understood that, in some other embodiments, the tube body 111 is not limited to a quartz pipe transparent to infrared light, and may be made of other window materials, such as transparent ceramics and diamond, that allow light waves to pass through.

In this embodiment, the tube body 111 is a hollow structure. Specifically, in some embodiments, the cross section of the tube body 111 may be approximately circular, and the outer diameter D2 of the tube body 111 may be controlled to be 1.6 mm to 3.5 mm (including end values of 1.6 mm and 3.5 mm, and any value between the two end values). The diameter D2 of the tube body 111 is greater than 1.6 mm, and the tube body 111 has certain strength. The diameter D2 of the tube body 111 is 3.5 mm, and the tube body 111 can match the aerosol-generating substrate 200. The thickness of the pipe wall of the tube body 111 is 0.15 mm to 0.6 mm (including end values of 0.15 mm and 0.6 mm, and any value between the two end values). Of course, it may be understood that, in some other embodiments, the cross section of the tube body 111 is not limited to a circular shape, and may be, for example, an oval, a prism, or a square. The thickness of the pipe wall of the tube body 111 is controlled to be greater than 0.15 mm, to mainly improve the overall strength of the tube body 111 and ensure the reliability of use of the tube body 111. By controlling the thickness T of the pipe wall of the tube body 111 to be less than 0.6 mm, impact of the heat capacity of the tube body 111 on a heating rate may be controlled, and light wave transmission efficiency may be controlled. Specifically, the heating rate and light wave transmission efficiency may be improved. In some embodiments, the wall thickness of the tube body 111 may be partially increased. For example, the thickness of the lower part of the tube body is greater than that of the upper part of the tube body; the upper part corresponds to the heating element 112, and the upper part has a thin-wall structure to ensure infrared light transmittance and reduce the heat capacity; and to ensure a fixing effect, the lower part is thickened to ensure the strength. In some embodiments, the length L3 of the tube body 111 may be 13 mm to 29 mm (including end values of 13 mm and 29 mm, and any value between the two end values). By controlling the length L3 of the tube body 111 to be greater than 13 mm, excess temperature of a base 13 assembled with the tube body 111 due to an excessively short tube body 111 may be avoided, thereby avoiding a fact that the excess temperature of the base 13 negatively affects elements in the power supply component 20 and the outer wall of the holder 12. By controlling the length L3 of the tube body 111 to be less than 29 mm, instruments may be controlled to be minimized, and the fact that the overall strength is reduced due to an excessively long tube body 111 and that the dimension of the entire heating component 10 needs to be increased because the excessively long tube body cannot match the holder 12 can be prevented.

In this embodiment, the tube body 111 includes a main body portion 111a and a pointed top portion 111b. The main body portion 111a may be cylindrical and hollowed. It may be understood that, in some other embodiments, the main body portion 111a is not limited to a cylindrical shape, and may be in a cuboid shape or other shapes. The pointed top portion 111b is arranged at one end of the main body portion 111a, and by arranging the pointed top portion 111b, at least part of the heating structure 11 is conveniently arranged in the aerosol-generating substrate 200 in a pluggable manner.

In this embodiment, at least part of the cavity 1110 is formed on the inner side of the main body portion 111a. The cavity 1110 in the main body portion 111a is a cylindrical cavity, and may be arranged in an unsealed manner. Specifically, the cross section of the cavity 1110 may be circular. Of course, it may be understood that, in some other embodiments, the cross section of the cavity 1110 is not limited to a circular shape. When the heating element 112 is mounted in the cavity 1110, the cavity 1110 is not required to be vacuumized or filled with inert gas. In some embodiments, the tube body 111 has a pipe opening 1111. The pipe opening 1111 is formed at one end of the main body portion 111a away from the pointed top portion 111b, communicated with the cavity 1110, and configured for the heating element 112 to be mounted in the cavity 1110.

In this embodiment, the cavity 1110 has a second dimension in the transverse direction. Specifically, the cross section of the cavity 1110 is approximately circular. The second dimension may further be the radial dimension of the cavity 1110. The second dimension may be 0.7 mm to 3 mm (including end values of 0.7 mm and 3 mm, and any value between the two end values). That is, the diameter of the cavity 1110 is approximately 0.7 mm to 3 mm. Of course, it may be understood that, in some other embodiments, if the cross section of the cavity 1110 is square, the second dimension may be the width of the cavity 1110.

In this embodiment, the heating element 112 may include a heating portion 1121, two conductive portions 1122, and two connection portions 1123. In some embodiments, the heating portion 1121 is arranged in the tube body 111 and at least partially spaced apart from the pipe wall of the tube body 111, and may radiate infrared light in a powered-on state. The infrared light may pass through the tube body 111 to the aerosol-generating substrate 200, to accurately atomize the aerosol-generating substrate 200 mainly in an infrared waveband of 2 μm to 5 μm. Specifically, in some embodiments, the heating portion 1121 is completely not in contact with the inner wall of the main body portion 111a, and a gap P is reserved between the heating portion 1121 and the inner wall of the main body portion 111a. The gap P may be controlled to be 0.05 mm to 0.5 mm (including end values of 0.05 mm and 0.5 mm, and any value between the two end values). Each conductive portion 1122 is connected to one of the connection portions 1123, and is connected to the heating portion 1121 through the connection portion 1123. The two conductive portions 1122 are arranged at an interval and are mutually independent. The two conductive portions 1122 may be led out from the tube body 111 and in conductive connection with the power supply component 20. Each connection portion 1123 is arranged corresponding to one of the conductive portions 1122, located between the conductive portion 1122 and the heating portion 1121, and configured to connect the conductive portion 1122 and the heating portion 1121. In some other embodiments, the top of the heating portion 1121 is in contact with and matches the top of the tube body 111, and the contact area is minimized, such as point contact or line contact, to avoid large-area contact to the greatest extent.

In this embodiment, the heating portion 1121 may be approximately cylindrical, and further has a first end portion 112M and a second end portion 112N. The first end portion 112M and the second end portion 112N are arranged in the axial direction of the heating portion 1121. Specifically, the heating portion may be in a spiral column shape. It may be understood that, in some other embodiments, the heating portion 1121 is not limited to the spiral column shape, and may be a longitudinal sheet, an M-type structure, an N-type structure, or a structure in another shape. The heating portion 1121 may be formed by winding at least one elongated heating body 1120. Specifically, in some embodiments, the heating body 1120 may be one piece, and two ends of the heating body 1120 may be bent and then be wound in a single-spiral or double-spiral winding manner. In some embodiments, a plurality of heating bodies 1120 may be provided. One end of the plurality of heating bodies 1120 may be connected and wound to form the heating portion 1121 in a single-spiral structure, a double-spiral structure, an M-type structure, or an N-type structure.

In this embodiment, the heating element 112 has a first dimension in the transverse direction. In this embodiment, the transverse direction of the heating portion 1121 is the radial dimension (that is, the extension direction of the radius or diameter of the spiral column shape of the heating portion). In some embodiments, the first dimension may be the radial dimension of the heating portion 1121, and the first dimension may be 0.6 mm to 2.5 mm (including end values of 0.6 mm and 2.5 mm, and any value between the two end values). In this embodiment, that is, the diameter D1 of the heating portion 1121 may be 0.6 mm to 2.5 mm (including end values of 0.6 mm and 2.5 mm, and any value between the two end values). The diameter of the heating portion 1121 is selected with reference to requirements for resistance, high-temperature strength, and deformation resistance. In some other embodiments, if the heating portion 1121 is in a square column shape, the first dimension may be the width of the heating portion 1121. In some embodiments, the radial dimension of the heating portion 1121 may be understood as a cylindrical body formed by revolving the heating portion along the axis of the heating portion. At this moment, the diameter or radius of the cross section of the cylindrical body is the radial dimension.

In this embodiment, a ratio of the first dimension to the second dimension is more than or equal to 0.65 and less than 1. That is, a ratio of the radial dimension of the heating portion 1121 to the radial dimension of the cavity 1110 is more than or equal to 0.65 and less than 1. The radial dimension of at least part of segments of the heating portion 1121 is configured to be more than or equal to the radial dimension of a single heating body 1120 and less than the radial dimension of the cavity 1110. Specifically, the radial dimension of any position of the heating portion 1121 is configured to be more than or equal to the radial dimension of the single heating body 1120 and less than the radial dimension of the cavity 1110, whereby the whole heating portion 1121 is spaced apart from the pipe wall of the main body portion 111a.

The radial dimension of the heating portion 1121 is configured to be more than or equal to 0.6 mm, whereby excessive resistance caused by an excessively thin (less than 0.6 mm) heating portion 1121 can be avoided. In other words, the aerosol-generating substrate 200 may be rapidly heated to quickly generate smoke without power increase or addition of a boost module, and manufacturing costs of the heating structure 11 are reduced. In addition, the degree of high-temperature deformation of the heating portion 1121 also can be reduced, and the heating portion 1121 maintains a set spacing from the pipe wall of the tube body 111. It should be noted that, the heating structure 11 is configured to heat the aerosol-generating substrate 200, to allow the aerosol-generating substrate 200 to generate smoke within 1-3 s. By configuring the radial dimension of the heating portion 1121 to be less than 2.5 mm, the tube body 111 may be controlled not to be oversize while ensuring that the heating portion 1121 does not adhere to the tube body 111, to further avoid excessive vaping resistance during vaping or difficult assembly of the tube body 111 with the aerosol-generating substrate 200, thereby improving consumer experience.

In this embodiment, the length L1 of the heating portion 1121 may be selected to be 5 mm to 12 mm (including end values of 5 mm and 12 mm, and any value between the two end values). It should be noted that the length L1 of the heating portion 1121 may be designed to match different aerosol-generating substrates 200, and the length L1 of the heating portion 1121 is selected with reference to atomization of the aerosol-generating substrate 200, temperature field control, bottom deposit, and the like. The length L1 of the heating portion 1121 has a significant impact on the atomization uniformity of the aerosol-generating substrate 200. While controlling not to deposit at the bottom, the length L1 of the heating portion 1121 is controlled to be more than or equal to 5 mm, and more uniform atomization indicates a better overall vaping experience of aerosol generated by the aerosol-generating substrate 200. The length of the heating portion 1121 is also controlled not to be excessive, and an excessively long heating portion 1121 causes severe atomization at the bottom of the aerosol-generating substrate 200, and further causes materials such as an atomizing substrate to deposit in the extractor 40, thereby leading to severe deposition and arising a cleaning problem.

In this embodiment, the entire temperature of the heating portion 1121 may be higher than the temperature of the connection portion 1123 and the temperature of the conductive portion 1122, and a first high-temperature area for heating the aerosol-generating substrate 200 is formed on the heating portion 1121. In this embodiment, the length of the first high-temperature area may be more than or equal to one third of the length of the aerosol-generating substrate 200 and less than or equal to three quarters of the length of the aerosol-generating substrate 200. In some embodiments, the length of the first high-temperature area may be selected to be 5 mm to 11 mm (including end values of 5 mm and 11 mm, and any value between the two end values). By controlling the length of the first high-temperature area to be 5 mm to 11 mm (including end values of 5 mm and 11 mm, and any value between the two end values), the aerosol-generating substrate 200 heated by the first high-temperature area is allowed to quickly generate smoke, and the bottom deposit of the aerosol-generating substrate 200 may be controlled, for example, to be reduced. In some other embodiments, the temperature field of the heating portion 1121 may be controlled by adjusting a density level of spiral segments of the heating portion 1121 or a density level of the heating bodies 1120 wound to form the heating portion 1121, whereby different temperature areas may be formed on the heating portion 1121. In some other embodiments, when the heating portion 1121 is in a cylindrical shape, a column shape, or a sheet shape, the heating portion 1121 may be hollowed, whereby different temperature areas may be formed on the heating portion 1121.

In this embodiment, a second high-temperature area is formed on the outer side of the pipe wall of the tube body 111, and located on the periphery of the first high-temperature area. Because the tube body 111 has a temperature equalization effect, the length L2 of the second high-temperature area may be greater than that of the first high-temperature area, and may be expanded by 1-4 mm relative to the length of the first high-temperature area. In some embodiments, the length L2 of the second high-temperature area may be 7 to 12 mm (including end values of 7 mm and 12 mm, and any value between the two end values). The length of the second high-temperature area is controlled to be 7 mm to 12 mm (including end values of 7 mm and 12 mm, and any value between the two end values), and the uniformity and consistency of the temperature field in the aerosol-generating substrate 200 is ensured.

The lengths of the outer wall of the tube body 111 and the temperature field of the heating portion 1121 are designed to match the aerosol-generating substrate 200 with a varying length of 10 mm to 18 mm. By setting the length of the second high-temperature area formed on the outer side of the pipe wall of the tube body 111 to be less than that of the aerosol-generating substrate 200, the bottom temperature of the aerosol-generating substrate 200 may be controlled to be relatively low. In this way, a deposit generated on the upper part of the aerosol-generating substrate 200 in the baking process is absorbed by low-temperature segments of the aerosol-generating substrate 200 at the bottom, rather than deposited in the extractor 40, thereby avoiding a cleaning problem.

In the conventional technology, most heating bodies are powered up to generate heat, and the temperature of the heating body is generally within 500° C. Therefore, in the conventional technology, the heating body needs to be in close contact with the tube body 111, and the tube body 111 needs to be in close fit with the aerosol-generating substrate 200, to achieve high-efficient transmission of heat. However, in this embodiment, the temperature of the heating portion 1121 may reach 500-1200° C., which is far higher than the temperature reached by a heating body in the conventional technology. By using the dimension of the heating portion 1121, the wall thickness of the tube body 111, the spacing between the heating portion 1121 and the tube body 111, the length L1 of the heating portion 1121, the length L3 of the tube body 111, and the like described above, the temperature of the heating structure 11 can be better controlled, to prevent the heating structure 11 from burning the aerosol-generating substrate 200, improve the vaping experience of the aerosol generated by the aerosol-generating substrate 200, and achieve rapid smoke emergence and a large amount of smoke and vaping experience at the beginning. In addition, burning of the aerosol-generating substrate 200 and excess temperature of the entire aerosol-generating device 100, due to excess temperature of the tube body 111, are also avoided.

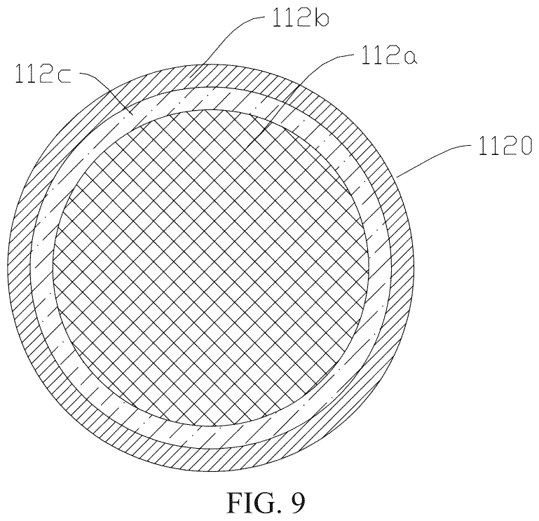

As shown in FIG. 9, in this embodiment, the heating body 1120 may be arranged longitudinally (that is, the length direction of the heating portion is approximately parallel to the axial direction of the tube body, or the included angle is less than 30°), and may be approximately circular in the cross section. Of course, it may be understood that, in some other embodiments, the cross section of the heating body 1120 is not limited to a circular shape, and may be in a square shape or other shapes. In some embodiments, the heating body 1120 may include a heating substrate 112a and a heat radiating layer 112b arranged on the heating substrate 112a. The heating substrate 112a may generate heat in a powered-on state, and the heating substrate 112a may be a conventional heating wire or heating sheet. Specifically, the heating substrate 112a may be a metal wire made of a metal material with good high-temperature oxidation resistance, high stability, and low tendency to deform, such as a nickel-chromium alloy (such as a nickel-chromium alloy wire) or an iron-chromium-aluminum alloy (such as an iron-chromium-aluminum alloy wire). The heat radiating layer 112b may be an infrared layer. The infrared layer may be an infrared layer forming substrate that is formed, through high-temperature heat treatment, on the heating substrate 112a, and may radiate infrared light. The infrared layer forming substrate may be a silicon carbide substrate, a spinel substrate, or a composite substrate thereof. It may be understood that, in some other embodiments, the heat radiating layer 112b is not limited to the infrared layer. In some other embodiments, the heat radiating layer 112b may be a composite infrared layer. In some embodiments, the heating body 1120 may further include an anti-oxidation layer 112c formed between the heating substrate 112a and the heat radiating layer 112b. In some embodiments, the heating substrate 112a is subjected to high-temperature heat treatment to generate a dense oxidation film on the surface of the heating substrate itself, and the oxidation film may form the anti-oxidation layer 112c.

As further shown in FIG. 3 to FIG. 8, in this embodiment, the two conductive portions 1122 are arranged at the second end portion 112N of the heating portion 1121, and each of the conductive portions 1122 may be connected to one end of the heating body 1120. Each conductive portion 1122 may be led out from the pipe opening 1111, and the segment of each conductive portion 1122 led out from the pipe opening 1111 may be bent. In this embodiment, the conductive portions 1122 may be arranged longitudinally and may be leading wires. Of course, it may be understood that, in some other embodiments, the conductive portions 1122 are not limited to the leading wires, and may be conductive strips, conductive pins, or other conductive structures. In some embodiments, the conductive portions 1122 and the heating portion 1121 may be welded to form an integral structure. It may be understood that, in some other embodiments, the connecting mode of the conductive portions 1122 and the heating portion 1121 is not limited to welding, and may alternatively be insertion or other modes. The conductive portions 1122 and the heating portion 1121 are fixedly arranged, and the two conductive portions 1122 are led out from the same end of the heating portion 1121, thereby facilitating installation of the heating element 112. In some embodiments, the power supply component 20 includes two electrodes, and each conductive portion 1122 may be in conductive connection with one of the electrodes. In some embodiments, the conductive portions 1122 may be directly welded to the electrodes. In some other embodiments, the conductive portions 1122 may be in contact with the electrodes to be conducted. For example, one end of the conductive portions 1122 may be connected to or form a first contact, and each electrode is provided with a second contact. When the heating component 10 and the power supply component 20 are assembled, the first contact and the second contact may be in contact to be conducted. The heating component 10 and the power supply component 20 may be assembled in a detachable manner through contact connection.

In this embodiment, the connection portions 1123 are located at the second end portion 112N, and may form an integral structure with the conductive portions 1122 and the heating portion 1121. Specifically, the connection portions 1123 may be welding spots. In some other embodiments, the connection portions 1123 are not limited to the welding spots, and may be connecting sleeves or other connection structures. In some embodiments, the cross-sectional area of the connection portion 1123 may be larger than that of the conductive portion 1122, thereby facilitating positioning and installation of the heating element 112. Specifically, the cross section of the connection portion 1123 may be approximately circular. It may be understood that, in some other embodiments, the cross section of the connection portion 1123 is not limited to a circular shape, and may be in a square shape, an oval shape, or other shapes. In some embodiments, the cross-sectional area of the connection portion 1123 is 0.07 mm² to 0.8 mm². Further, the cross section of the connection portion 1123 may be circular, and the diameter of the connection portion 1123 is 0.2 mm to 1.5 mm (including end values of 0.2 mm and 1.5 mm, and any value between the two end values).

In this embodiment, the heating structure 11 further includes an insulating part 113. The insulating part 113 is at least partially mounted in the tube body 111. Specifically, the insulating part 113 may be partially located in the tube body 111, and partially passes through the pipe opening 1111. The insulating part 113 may space the two conductive portions 1122, and is configured to insulate the two conductive portions 1122. In some embodiments, the insulating part 113 may play a role in fixing the heating element 112, and may block the pipe opening 1111, whereby the cavity 1110 forms a sealed cavity. In some embodiments, the insulating part 113 may be fixed in the tube body 111. Specifically, the part of the pipe wall, located in the tube body 111, of the insulating part 113 may be fixed to the inner wall of the tube body 111 through an adhesive, to prevent the insulating part 113 from moving. Certainly, it may be understood that, in some other embodiments, the insulating part 113 is not limited to being fixed through the adhesive. For example, the insulating part 113 may alternatively be abutted against a base 13 on the holder 12.

In this embodiment, the insulating part 113 has a cylindrical shape, and the cross-sectional shape of the insulating part 113 may be equivalent to the cross-sectional shape of the cavity 1110 of the tube body 111. In addition, the cross-sectional area of the insulating part 113 matches the cross-sectional area of the cavity 1110 of the tube body 111. Specifically, the insulating part 113 is cylindrical, the axial direction of the insulating part 113 is the same as the axial direction of the cavity 1110, and the diameter of the insulating part 113 matches the diameter of the cavity 1110. Specifically, the diameter of the insulating part 113 may be slightly smaller than the diameter of the cavity 1110. It may be understood that, in some other embodiments, the insulating part 113 is not limited to a cylindrical shape, and may be in a square column shape or other shapes. In some embodiments, the insulating part 113 may be a ceramic body, a quartz pipe, or any other insulating structure.

In this embodiment, the insulating part 113 may include a first end 113a and a second end 113b. The first end 113a and the second end 113b are both located in the axial direction of the insulating part 113, and are arranged oppositely. The first end 113a may be located on the outer side of the tube body 111, that is, the first end 113a may pass through the pipe opening 1111. It may be understood that, in some other embodiments, the first end 113a may alternatively be arranged close to the outer side of the tube body 111, that is, the first end 113a may be arranged in or close to the pipe opening 1111. Each conductive portion 1122 may pass through the second end 113b and the first end 113a, and a portion of each conductive portion 1122 close to the first end 113a may be bent, and may pass through one side of the insulating part 113, thereby limiting the insulating part 113.

In this embodiment, the insulating part 113 is provided with a channel 1131 extending from the second end 113b to the first end 113a, and two channels 1131 are provided. Each channel 1131 is arranged corresponding to one of the conductive portions 1122, and configured to allow one of the conductive portions 1122 to pass through. In some embodiments, the two channels 1131 are independently arranged, and are not communicated with each other. The cross section of the channel 1131 may be approximately circular. In some other embodiments, the cross section of the channel 1131 is not limited to a circular shape, and may be square or U-shaped. Two through holes or two through slots that penetrate through the second end 113b and the first end 113a may be formed on the insulating part 113, and each channel 1131 may be formed in each through hole or each through slot. It may be understood that, in some embodiments, a through hole and a through slot may alternatively be formed on the insulating part 113, the through hole may form one channel 1131, and the through slot may form the other channel 1131. In some embodiments, the cross-sectional area of the channel 1131 may match the cross-sectional area of the conductive portion 1122. Specifically, the cross-sectional area of the channel 1131 may be slightly larger than the cross-sectional area of the conductive portion 1122. In some embodiments, the cross-sectional area of the channel 1131 may be 0.03 mm² to 0.28 mm² (including end values of 0.03 mm² and 0.28 mm², and any value between the two end values). Specifically, in some embodiments, the diameter of the channel 1131 may be 0.2 mm to 0.6 mm (including end values of 0.2 mm and 0.6 mm, and any value between the two end values).

In this embodiment, the connection portion 1123 may be arranged at the second end 113a. Specifically, the connection portion 1123 may be fixed to the second end 113a. Specifically, the cross-sectional area of the connection portion 1123 may be greater than that of the channel 1131, that is, the connection portion 1123 cannot pass through the channel 1131, and may be fixed to the second end 113a. In some other embodiments, the connection portion 1123 may alternatively be fixed to the second end 113a through gluing, and is not limited to being fixed by enlarging the cross-sectional area of the connection portion 1123. By fixing the connection portion 1123 to the second end of the insulating part 113, the heating element 112 may be fixed in the tube body 111, prevented from moving toward the side of the pipe opening 1111, and centrally fixed in the tube body 111, and forms a uniform gap with the pipe wall of the tube body 111. Therefore, the temperature of the tube body 111 is uniform, and the heating element 112 is conveniently installed, thereby improving the installation efficiency of the heating element 112 and improving the installation stability and reliability of the heating element 112.

Specifically, when the heating element 112 is assembled with the tube body 111, the heating element 112 may be assembled with the insulating part 113, the connection portion 1123 is located at the second end 113b of the insulating part 113, and then the connection portion 1123 and the insulating part 113 are mounted in the tube body 111 together. One end of the heating portion 1121 away from the conductive portion 1122 may be in interference fit with the part of the inner wall of the pointed top portion 111b, that is, may abut against the pointed top portion 111b, to further limit movement of the heating element 112 toward the tip of the pointed top portion 111b, that is, the heating element 112 may be fixed to at least two positions on the axis, to keep the heating element 112 centrally arranged in the tube body 111 and form a uniform gap with the pipe wall of the tube body 111.

In this embodiment, the outer wall of the tube body 111 is provided with a positioning portion 114. The positioning portion 114 may be configured for overall installation and positioning of the heating structure 11. Specifically, the positioning portion 114 may facilitate positioning and installation of the heating structure 11 on the holder 12, to limit movement of the heating structure 11. In some embodiments, the positioning portion 114 is arranged close to the pipe opening 1111. In some embodiments, the positioning portion 114 may be an annular structure, and may be, for example, a fixed flange. In some embodiments, the positioning portion 114 may be fixed to the outer wall of the tube body 111 through a connection structure. Specifically, the connection structure may be a gluing structure such as an adhesive. It may be understood that, in some other embodiments, the positioning portion 114 may be integrally formed with the tube body 111. Specifically, the positioning portion 114 may be integrally formed with the tube body 111 through injection molding. In some embodiments, the distance between the second end portion 112N of the heating portion 1121 and the positioning portion 114 is more than or equal to one tenth of the length of the tube body 111 and less than or equal to three quarters of the length of the tube body 111. Specifically, the distance between the second end portion 112N and the positioning portion 114 is 2 mm to 12 mm (including end values of 2 mm and 12 mm, and any value between the two end values). The distance between the second end portion 112N of the heating portion 1121 and the positioning portion 114 is more than or equal to one tenth of the length of the tube body 111 and less than or equal to three quarters of the length of the tube body 111. Specifically, the distance between the connection portion 1123 and the end surface, opposite to the pipe opening 1111, of the positioning portion 114 may be 5 mm to 10 mm (including end values of 5 mm and 10 mm, and any value between the two end values), whereby most of the heating portion 1121 is inserted into the aerosol-generating substrate 200 along with the tube body 111, to avoid excess temperature of the holder 12 due to excess temperature at the bottom of the tube body 111.

In this embodiment, the holder 12 may include a holder body 121. The holder body 121 may be partially embedded in the housing 30, and is in interference fit with the housing 30. The holder body 121 is provided with an accommodating cavity 1210. The accommodating cavity 1210 may be configured to accommodate the extractor 40 of the aerosol-generating substrate 200. The accommodating cavity 1210 may be an open structure having an approximately L-shaped opening. The opening may extend from the top surface of the holder body 121 to the side wall of the holder body 121. The holder body 121 is provided with a supporting wall 122, and the supporting wall 122 may be configured to support the extractor 40. In some embodiments, the holder body 121 is provided with a mounting hole 123. The mounting hole 123 may be located on the supporting wall 122, and is configured to allow part of the heating structure 11 to pass through. In some embodiments, the mounting hole 123 may allow part of the tube body 111 to pass through. Specifically, the part of the tube body 111 that is located on one side of the positioning portion 114 away from the pipe opening 1111 may pass through the mounting hole 123.

In this embodiment, the heating component 10 further includes a base 13. The base 13 is arranged at the bottom of the holder body 121. The base 13 includes a bottom wall 131 and a limiting structure 132 arranged on the bottom wall 131. The bottom wall 131 is located at one end of the holder 12, and may abut against the insulating part 113 that passes through the pipe opening 1111, whereby the insulating part 1133 is fixed in the tube body 111. The limiting structure 132 is located in the holder 12. Specifically, the limiting structure 132 is located on the side of the supporting wall 122 away from the accommodating cavity 1210. The limiting structure 132 may match the positioning portion 114 to limit a position, so as to limit movement and rotation of the positioning portion 114, thereby limiting movement and rotation of the heating structure 11. Specifically, in some embodiments, the limiting structure 132 may surround the positioning portion 114, to limit rotation of the positioning portion 114. In some embodiments, the inner wall of the limiting structure 132 is provided with a limiting protruding stage 1321, and the limiting protruding stage 1321 may abut against the positioning portion 114, to limit movement of the positioning portion 114. In some embodiments, the base 13 and the holder 12 are connected in a detachable manner. When the heating component 10 is assembled, the heating structure 11 may be mounted on the base 13 first, and then part of the tube body 111 of the heating structure 11 is inserted in the accommodating cavity 1210 through the mounting hole 123, whereby the heating structure 11 and the base 13 are assembled to the holder 12 together. The heating structure 11 may be conveniently replaced by arranging the base 13 in the detachable manner.

In this embodiment, the heating component 10 further includes a sealing structure 14. The sealing structure 14 is arranged between the outer wall of the heating structure 11 and the inner wall of the mounting hole 123. Specifically, the sealing structure 14 may be sleeved on the periphery of the tube body 111, is located on the side of the positioning portion 114 away from the pipe opening 1111, and may be embedded in the mounting hole 123, to seal a gap between the heating structure 11 and the mounting hole 123, so as to buffer vibration and prevent aerosol from spilling out of the mounting hole 123. In some embodiments, the sealing structure 14 may be a sealing ring, such as a rubber ring or a silicon ring.

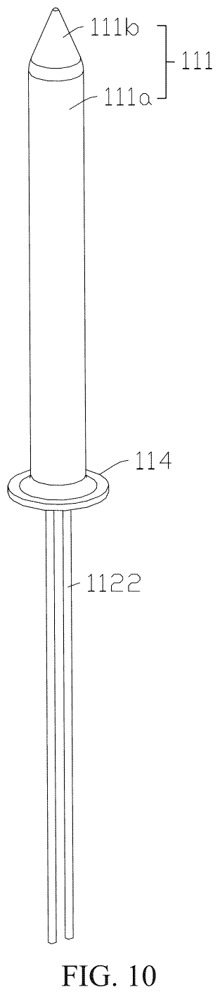

FIG. 10 shows a second embodiment of the aerosol-generating device of the present disclosure. The second embodiment differs from the first embodiment in that the positioning portion 114 is integrally formed with the tube body 111, the positioning portion 114 is a turned-up structure, and the turned-up structure may be formed by outward turning the pipe wall of the tube body 111 close to the end of the pipe opening 1111.

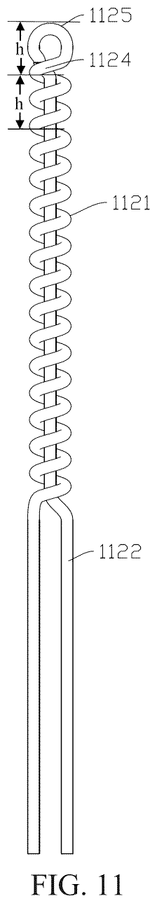

FIG. 11 shows a third embodiment of the aerosol-generating device of the present disclosure. The end portion of the heating portion 1121 close to the pointed top portion 111b has the maximum radial dimension or width of the heating portion 1121. Specifically, the heating portion 1121 includes a spiral segment 1124 arranged close to the pointed top portion 111b. One end of the spiral segment close to the pointed top portion 111b includes an annular portion 1125. The annular portion 1125 has the maximum radial dimension of the heating portion 1121, that is, the diameter of the annular portion 1125 is greater than the diameter of the cross section of another position of the heating portion 1121. In this way, the end portion of the heating portion 1121 close to the pointed top portion 111b can achieve installation limitation, and a middle part of the heating portion 1121 is not in direct contact with the inner wall of the main body portion 111a. In addition, the heat sink area can be enlarged, resistance can be reduced, and the end portion of the heating portion 1121 close to the pointed top portion 111b is prevented from excess temperature. It may be understood that, the radial dimension of the annular portion 1125 may be equal to the radial dimension of the spiral segment, provided that the spiral segment and the pipe wall are arranged at an interval and the interval is controlled to be 0.05 mm to 0.5 mm (including end values of 0.05 mm and 0.5 mm, and any value between the two end values).

As shown in FIG. 11, in some other embodiments, one end of the spiral segment 1124 close to the pointed top portion 111b includes a top. The top has a set height h in the axial direction. The resistance value of the spiral segment that is adjacent to the top and that has the same height h is greater than that of the top. That is, the resistance value of the top of the heating portion 1121 that matches the pointed top portion 111b is relatively low, and heat generated by the top of the heating portion 1121 in a powered-on state is lower than heat generated by another part, thereby avoiding excess temperature at the top of the heating structure 11, avoiding burning of the aerosol-generating substrate 200, and improving the vaping experience of aerosol. In some embodiments, the spiral segment may include a spiral portion and a straight-line portion inside the spiral portion, or may only include the spiral portion.

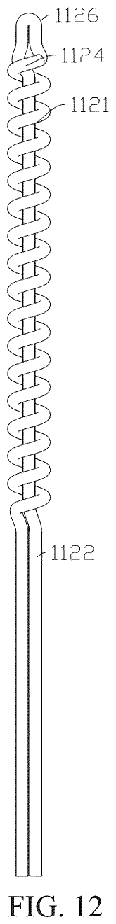

FIG. 12 shows a fourth embodiment of the aerosol-generating device of the present disclosure. The heating portion 1121 includes a spiral segment 1124 close to the pointed top portion 111b, and the radial dimension or the width dimension of the end portion of the spiral segment 1124 close to the pointed top portion 111b is less than the maximum radial dimension of the spiral segment 1124. In this embodiment, the spiral segment 1124 close to the pointed top portion 111b includes a bending portion 1126, and the width of the bending portion is less than the maximum radial dimension of the spiral segment. That is, the width dimension of the top of the heating portion 1121 is relatively small. The top of the heating portion 1121 may match the pointed top portion 111b of the tube body 111 to limit a position, while the contact area with the pointed top portion 111b may be reduced, and heat generation and light wave radiation may be reduced. That is, the temperature of the end close to the pointed top portion 111b is lower than that of the portion away from the pointed top portion 111b, to avoid excess temperature at the top of the heating structure 11. In addition, by reducing the width dimension of the top of the heating portion 1121, the heat capacity of the heating portion 1121 may be reduced.

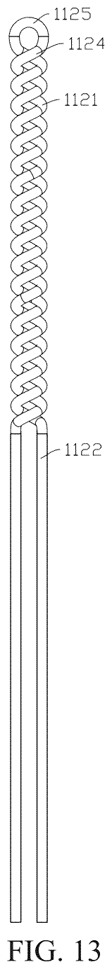

FIG. 13 shows a fifth embodiment of the aerosol-generating device of the present disclosure. The spacing between the annular portion 1125 and an adjacent spiral segment is greater than the spacing between spiral segments, and spiral segments away from the annular portion 1125 are spaced apart from the inner wall of the tube body 111, so as to reduce radiation of light waves generated when the heating portion 1121 is powered on, thereby avoiding excess temperature at the top of the heating structure 11, avoiding burning of the aerosol-generating substrate 200, and improving the vaping experience of aerosol.

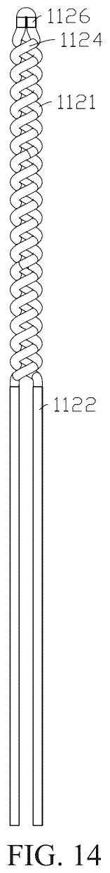

FIG. 14 shows a sixth embodiment of the aerosol-generating device of the present disclosure. The spacing between the bending portion 1126 and an adjacent spiral segment is greater than the spacing between spiral segments, and spiral segments away from the bending portion 1126 are spaced apart from the inner wall of the tube body 111, so as to reduce radiation of light waves generated when the top of the heating structure 11 is powered on, thereby avoiding excess temperature at the top of the heating structure 11, avoiding burning of the aerosol-generating substrate 200, and improving the vaping experience of aerosol.

In some other embodiments, one end of the spiral segment close to the pointed top portion 111b is not limited to including the bending portion 1126 or the annular portion 1125. One end of the spiral segment 1124 close to the pointed top portion 111b may only include a tip or a flat portion. The width of the tip or the flat portion may be less than the outer diameter of the spiral segment 1124. The tip and the flat portion are abutted against the top of the pointed top portion 111b. The spiral segment 1124, away from the tip or the flat portion, of the heating portion 1121 may be spaced apart from the inner wall of the tube body 111. That is, the heating portion 1121 may match the pointed top portion 111b through the tip or the flat portion to limit a position, and may reduce radiation of light waves generated during power-on by arranging the tip or the flat portion, to avoid excess temperature at the top of the heating structure 11, avoid burning of the aerosol-generating substrate 200, and improving vaping experience of aerosol.

In some other embodiments, a limiting portion is arranged between the heating portion 1121 and a insulating part 113, to limit the distance between the heating portion 1121 and the insulating part 113. Specifically, the limiting portion may be an insulating sleeve that is made of alumina or zirconia and that is sleeved on the end portion of a heating wire or the conductive portion 1122. The limiting portion may alternatively be a thickened portion of the end portion of the heating wire or a thickened portion of the conductive portion 1122. The limiting portion limits a position on the top surface of the insulating part 113, to limit a position of the conductive portion 1122 after the conductive portion 1122 passes through the insulating part 113, thereby facilitating batch production, ensuring consistency of heating structures, and finally facilitating temperature control and vaping experience.

It should be noted that, the value ranges claimed in the foregoing solutions all include end values within the value ranges. For example, an infrared wavelength of 2-4.75 μm only means that the wavelength is more than or equal to 2 μm and less than or equal to 4.75 μm. Other ranges are equally understood and are not described one by one herein.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating structure, comprising:
a tube body having a cavity and a pipe wall transparent to infrared light; and
a heating element at least partially arranged in the cavity, at least partially spaced apart from the pipe wall, and configured to radiate infrared light to pass through the tube body so as to heat an aerosol-generating substrate,
wherein the heating element has a first dimension in a transverse direction,
wherein the cavity has a second dimension in the transverse direction, and
wherein a ratio of the first dimension to the second dimension is greater than or equal to 0.65 and less than 1.

2. The heating structure of claim 1, wherein the tube body comprises a main body portion and a pointed top portion arranged at one end of the main body portion, and
wherein an interior of the main body portion is hollow and forms at least part of the cavity.

3. The heating structure of claim 2, wherein the heating element comprises a heating portion arranged in the cavity,
wherein the heating portion has a spiral column shape, and
wherein the first dimension is a radial dimension of the heating portion and is 0.6 mm to 2.5 mm.

4. The heating structure of claim 1, wherein the cavity has a circular shape in a cross section, and the
wherein second dimension is a radial dimension of the cavity ranges from 0.7 mm to 3 mm.

5. The heating structure of claim 1, wherein the heating element comprises a heating portion arranged in the cavity, and
wherein the heating portion is arranged longitudinally, and
wherein the heating portion has a length of 5 mm to 12 mm.

6. The heating structure of claim 1, wherein a first high-temperature area is formed on the heating element, and
wherein a length of the first high-temperature area is greater than or equal to one third of a length of the aerosol-generating substrate and less than or equal to three quarters of the length of the aerosol-generating substrate.

7. The heating structure of claim 6, wherein a length of the first high-temperature area is 5 mm to 11 mm.

8. The heating structure of claim 6, wherein a second high-temperature area is formed on an outer side of the pipe wall of the tube body and located on a periphery of the first high-temperature area, and
wherein the second high-temperature area has a length of 7 mm to 12 mm.

9. The heating structure of claim 1, wherein the thickness of the pipe wall of the tube body ranges from 0.2 mm to 0.5 mm.

10. The heating structure of claim 1, wherein a length of the tube body ranges from 13 mm to 29 mm.

11. The heating structure of claim 3, wherein a gap between an inner wall of the main body portion and the heating portion ranges from 0.05 mm to 0.5 mm.

12. The heating structure of claim 3, wherein the heating portion is completely not in contact with an inner wall of the main body portion.

13. The heating structure of claim 3, further comprising:
a conductive portion,
wherein the heating portion has a first end portion and a second end portion in an axial direction of the heating portion,
wherein the conductive portion is arranged at the second end portion, and
wherein the conductive portion is led out from the tube body.

14. The heating structure of claim 13, wherein an outer side wall of the tube body is provided with a positioning portion configured for installation and positioning,
wherein the tube body comprises a pipe opening from which the conductive portion is led out,
wherein the positioning portion is arranged close to the pipe opening, and
wherein a distance between the second end portion and the positioning portion is greater than or equal to one tenth of a length of the tube body and less than or equal to three quarters of the length of the tube body.

15. The heating structure of claim 14, wherein a distance between the second end portion and the positioning portion is 2 mm to 12 mm.

16. An aerosol-generating device, comprising:
the heating structure of claim 1; and
a power supply component connected to the heating structure.
